(19) United States
(12) Patent Application Publication
(10) Pub. No.: US 2025/0209502 A1
(43) Pub. Date: Jun. 26, 2025

(54) INFORMATION PROCESSING DEVICE, INFORMATION PROCESSING METHOD, AND NON-TRANSITORY COMPUTER READABLE STORAGE MEDIUM

(71) Applicant: LY Corporation, Tokyo (JP)

(72) Inventors: Koji TSUKAMOTO, Tokyo (JP); Junichi SATO, Tokyo (JP)

(21) Appl. No.: 18/945,380

(22) Filed: Nov. 12, 2024

(30) Foreign Application Priority Data
Dec. 20, 2023 (JP) 2023-215275

(51) Int. Cl. G06Q 30/0241; G06Q 30/0251

(52) U.S. Cl. CPC G06Q 30/0276; G06Q 30/0271; G06Q 30/0277

(57) ABSTRACT

An information processing device according to the application concerned includes a specification receiving unit, a generating unit, and a providing unit. The specification receiving unit receives the specification of the landing page of a set of advertisement content. The generating unit inputs, as the input information to a generative AI, information containing the information about the landing page that is received as the specification by the specification receiving unit; and causes the generative AI to generate a set of advertisement content. The providing unit provides the set of advertisement content generated by the generating unit.

### CROSS-REFERENCE TO RELATED APPLICATION

The present application claims priority to and incorporates by reference the entire contents of Japanese Patent Application No. 2023-215275 filed in Japan on Dec. 20, 2023.

### BACKGROUND OF THE INVENTION

### 1. Field of the Invention

The present invention relates to an information processing device, an information processing method, and a non-transitory computer readable storage medium.

### 2. Description of the Related Art

Conventionally, a technology for delivering sets of advertisement content over the Internet is known. For example, in Japanese Patent Application Laid-open No. 2022-35340, a technology is proposed that delivers sets of advertisement content in relation to a search keyword input by the user.

However, there is further room for improvement in delivering more appropriate sets of advertisement content to the user.

### SUMMARY OF THE INVENTION

An information processing device includes a specification receiving unit, a generating unit, and a providing unit. The specification receiving unit receives specification of a landing page of a set of advertisement content. The generating unit inputs, as input information to a generative AI, information containing information about the landing page which is received as specification by the specification receiving unit, and causes the generative AI to generate a set of advertisement content. The providing unit provides the set of advertisement content generated by the generating unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining the information processing performed according to an embodiment;

FIG. 2 is a diagram illustrating an exemplary configuration of an information processing system according to the embodiment;

FIG. 3 is a diagram illustrating an exemplary configuration of an information processing device according to the embodiment;

FIG. 4 is a diagram illustrating an example of a user information table that is stored in a user information storing unit of the information processing device according to the embodiment;

FIG. 5 is a diagram illustrating an example of an advertisement content table that is stored in an advertisement content storing unit of the information processing device according to the embodiment;

FIG. 6 is a flowchart for explaining an example of the information processing performed by a processing unit of the information processing device according to the embodiment; and

FIG. 7 is a hardware configuration diagram illustrating an example of a computer that implements the functions of the information processing device according to the embodiment.

### DETAILED DESCRIPTION OF THE PREFERRED EMBODIMENTS

An illustrative embodiment (hereinafter, referred to as “embodiment”) of an information processing device, an information processing method, and a non-transitory computer readable storage medium according to the application concerned is described below in detail with reference to the accompanying drawings. However, the information processing device, the information processing method, and the non-transitory computer readable storage medium according to the application concerned is not limited by the embodiment described below. Moreover, in the embodiments described below, identical constituent elements are referred to by the same reference numerals, and their explanation is not given repeatedly.

### 1. Example of Information Processing

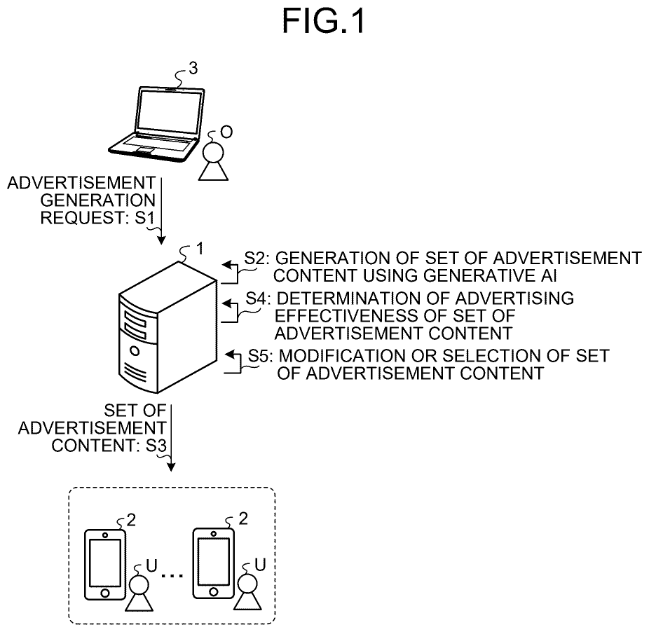

Firstly, explained below with reference to FIG. 1 is an example of the information processing performed according to the embodiment. FIG. 1 is a diagram for explaining the information processing performed according to the embodiment.

An information processing device 1 illustrated in FIG. 1 coordinates with a terminal device 2 of each user U and with a terminal device 3 of a business operator O, and provides each user U and the business operator O with a variety of information online. For example, the information processing device 1 is implemented using one or more servers or using a cloud system. Examples of the terminal devices 2 and 3 include smartphones, tablets, and personal computers.

The information processing device 1 provides an advertisement generation service or an advertisement delivery service. The advertisement generation service is a service for generating a set of advertisement content that guides the users U to the landing page provided by the business operator O. The advertisement delivery service is a service for delivering sets of advertisement content to the users U. For example, the advertisement delivery service delivers a set of advertisement content, which is generated by the advertisement generation service, to the users U.

A landing page is a page provided to the users U by way of a set of advertisement content or by way of a search result. A set of advertisement content generated by the advertisement generation service includes the link to a landing page. The link to a landing page either is a uniform resource locator (URL) of the landing page or is a shortened URL meant for redirecting to the URL of the landing page. However, a link is not limited to those examples.

Moreover, a landing page is configured using, for example, HTML (HyperText Markup Language), CSS (Cascading Style Sheets), JavaScript (registered trademark), or image files. However, those are not the only possible examples.

Each user U operates the corresponding terminal device 2 (by performing a click operation or a tap operation, for example) and selects a set of advertisement content. In response, the terminal device 2 accesses the URL of the landing page. Thus, the landing page corresponding to the selected set of advertisement content is obtained. Then, the terminal device 2 displays the obtained landing page.

Examples of a set of advertisement content include, but are not limited to, a set of display content, a set of listing content, and a set of video content. Examples of a set of display content include, but are not limited to, a banner advertisement, an SNS advertisement (SNS stands for Social Networking Service), and a native advertisement.

As illustrated in FIG. 1, the information processing device 1 receives an advertisement generation request sent from the terminal device 3 of the business operator O (Step S1). The advertisement generation request either includes the URL of the landing page specified by the operator O or includes information indicating the landing page itself. Thus, by receiving the advertisement generation request sent from the terminal device 3, the information processing device 1 receives the specification of the landing page of a set of advertisement content.

Then, the information processing device 1 inputs, as input information to a generative AI (Artificial Intelligence), the information containing the information about the landing page received as the specification at Step S1, and causes the generative AI to generate a set of advertisement content (Step S2).

Examples of a generative AI include a text generative AI, an image generative AI, and a multimodal generative AI. For example, a text generative AI represents a large-scale language model that is trained to estimate the next token from a token array and to output the estimated token. For example, a text generative AI is a transformer-based model or an RNN-based model (RNN stands for Recurrent Neural Network), or can also be a mixed model of such models. Alternatively, a text generative AI can be a complex system used in combination with a discrimination machine meant for preventing unauthorized use.

Examples of a transformer-based model include, but are not limited to, GPT (Generative Pre-trained Transformer) (registered trademark) or BARD (Bidirectional Auto Regressive Decoder). Examples of an RNN-based model include, but are not limited to, RWKV (Receptance Weighted Key Value).

An image generative AI represents an AI for generating images from texts; and examples thereof include, but are not limited to, StackGAN (Generative Adversarial Networks), AttnGAN, T2I (Text-to-Image) with Transformers, and Diffusion model. Moreover, for example, a Diffusion model can be DALL-E or Stable-Diffusion.

A multimodal generative AI is a generative AI meant for generating at least either a text, or an image, or an audio from at least either a text, an image, or an audio. Examples of a multimodal generative AI include, but are not limited to, GPT-4V and CM3Leon (Chameleon Multimodal Model).

Meanwhile, a generative AI is desirably trained in such a way that individual information is not included in the generation result thereof. Moreover, a generative AI can be a language model trained (for example, fine-tuned) for the dedicated purpose of generating sets of advertisement content. A generative AI is disposed in an external information processing device, and the information processing device 1 uses the generative AI via an application programming interface (API) provided by the external information processing device. Alternatively, the generative AI can be disposed in the information processing device 1.

At Step S2, in the information processing device 1, the information included in the input information as the information about a landing page represents, for example, the text information included in the landing page, or the image information indicating the landing page, or the text information and the image information included in the landing page. The text information represents information indicating the character strings included in the landing page. The image information represents information indicating the images included in the landing page.

For example, the information processing device 1 inputs, as the input information to a generative AI, information containing instruction information, which represents information for instructing generation of a set of advertisement content, and containing the information about the landing page; and causes the generative AI to generate a set of advertisement content.

The instruction information included in the input information contains, for example, information about a character string “You are an advertisement creator. Based on the input information about a landing page, please generate a set of advertisement content predicted to have high advertising effectiveness for that landing page.”. Examples of the advertising effectiveness include, but are not limited to, the selectivity of the concerned set of advertisement content (for example, the click-through rate or the tap rate) and the browsing rate of the landing page.

Meanwhile, in addition to having the instruction information and the information about the landing page, the information included in the input information can further contain target information representing the information that indicates the target for the concerned set of advertisement content. For example, the target information represents information indicating the users U who are targeted in a set of advertisement content.

The attributes of each user U include, for example, the demographic attributes or the psychographic attributes of the user U. Examples of the demographic attributes of the user U include, but are not limited to, the gender, the age, the profession, the place of residence, the annual income, and the family of the user U. Examples of the psychographic attributes of the user U include, but are not limited to, the interests and concerns, the lifestyle, and the set of values of the user U.

When the target information indicates the user U who is the target for the sets of advertisement content, the instruction information further contains the information about a character string “The attributes of the user targeted in the set of advertisement content are as follows.”.

Meanwhile, the generative AI used in the information processing device 1 can be a generative AI that is fine-tuned with the information for learning in the form of the information about the landing page of a set of advertisement content having high advertising effectiveness and the information containing a plurality of combinations with that set of advertisement content.

In that case, the information processing device 1 inputs, to the generative AI, the input information containing the information about the landing page, and causes the generative AI to generate a set of advertisement content; or inputs, to the generative AI, the input information further containing the target information, and causes the generative AI to generate a set of advertisement content.

In this way, in addition to inputting the information about the landing page to the generative AI, the information processing device 1 can also input the input information containing either one or both of the instruction information and the target information; and can cause the generative AI to generate a set of advertisement content.

Moreover, the information processing device 1 can cause the generative AI to generate a plurality of sets of advertisement content. For example, the information processing device 1 inputs, to the generative AI, the input information containing information about a character string “Generate 10 sets of advertisement content for the . . . landing page.”, and causes the generative AI to generate 10 sets of advertisement content.

Furthermore, for example, the information processing device 1 can input, to the generative AI, the input information containing the information about a landing page; and can cause the generative AI to output the information meant for collecting information related to the material to be included in a set of advertisement content.

For example, in the case of using the API provided by OpenAI, the information processing device 1 implements the function-calling function and causes the generative AI to output the information meant for collecting the information related to the material to be included in the set of advertisement content. The input information that is input to the generative AI has the following information included therein, for example: information containing function definition information, which is meant for defining the function name and the arguments of that function, and information about the landing page. Meanwhile, instead of including the function definition information, information indicating the name of the material can be included in the input information.

For example, based on the information output from the generative AI, the information processing device 1 collects the information related to the material to be included in a set of advertisement content; inputs, to the generative AI, the information related to the material to be included in a set of advertisement content; and causes the generative AI to generate a set of advertisement content.

Moreover, the information processing device 1 can input, to the generative AI, the input information containing the information about the landing page and can cause the generative AI to generate the information meant for generating a set of advertisement content; and then can input the generated information to the generative AI and can cause the generative AI to generate a set of advertisement content.

An advertisement generation request can also include base advertisement content. The base advertisement content represents the set of advertisement content that serves as the basis of the set of advertisement content generated at Step S2. Thus, when an advertisement generation request is received, the information processing device 1 receives the base advertisement content too.

Then, the information processing device 1 inputs, as the input information to the generative AI, information containing the information about the landing page and containing the base advertisement content, and causes the generative AI to generate a set of advertisement content that is similar to the base advertisement content.

For example, the information processing device 1 inputs, to the generative AI, the input information that contains the instruction information meant for causing the generative AI to generate a set of advertisement content similar to the base advertisement content, that contains the information about the landing page, and that contains the base advertisement content; and causes the generative AI to generate a set of advertisement content that is similar to the base advertisement content.

In that case, the instruction information contains, for example, the information about a character string “You are an excellent advertisement creator. Based on the input information about a landing page, please generate a set of advertisement content for that landing page. Please make the set of advertisement content, which is to be generated, similar to the input set of advertisement content serving as the basis.”. However, that is not the only possible example.

Meanwhile, when GPT-4 developed by OpenAI is used as the generative AI, the instruction information represents the information included in a system message indicating that “role” represents a message of the generative AI. Alternatively, the instruction information can represent the information included in a user message indicating that “role” represents a message from the user. Moreover, the information about the landing page, the target information, and the base advertisement content represent the information included in a user message. Alternatively, such information can represent the information included in a system message.

Then, the information processing device 1 provides the set of advertisement content generated at Step S2 (Step S3). For example, when an advertisement delivery request sent from the terminal device 2 of the user U is received, the information processing device 1 sends the set of advertisement content generated at Step S2 to the terminal device 2 and thus provides the user U with the set of advertisement content generated at Step S2.

Meanwhile, at Step S2, for example, when a plurality of sets of advertisement content is generated corresponding to a single landing page, the information processing device 1 selects, either randomly or according to predetermined rules, a single set of advertisement content from among the plurality of sets of advertisement content and provides the user U with the selected set of advertisement content.

Moreover, at Step S2, when a set of advertisement content is generated for each attribute of the user U, the information processing device 1 sends, to the terminal device 2, the sets of advertisement content which correspond to the attributes identified in the information included in the advertisement delivery request. Meanwhile, the operation at Step S3 is performed in a repeated manner.

Then, the information processing device 1 determines the advertising effectiveness of the set of advertisement content provided at Step S3 (Step S4). When a plurality of sets of advertisement content is generated at Step S2, the information processing device 1 determines the advertising effectiveness of each set of advertisement content.

Examples of the advertising effectiveness determined at Step S4 include, but are not limited to, the click-through rate (CTR) and the conversion rate (CVR). Alternatively, for example, the impression rate of the landing page can be used to determine the advertising effectiveness.

Meanwhile, at Step S4, the information processing device 1 can determine the advertising effectiveness of the set of advertisement content corresponding to each attribute of the user U to whom the sets of advertisement content are to be provided. For example, at Step S4, corresponding to each combination of the gender, the age, and the place of residence of the user U to whom the sets of advertisement content are to be provided (for example, a man in his twenties and living in Tokyo or a woman in her thirties and living in Osaka), the information processing device 1 determines the advertising effectiveness of the set of advertisement content.

Subsequently, based on the determination result of the advertising effectiveness as obtained at Step S4, the information processing device 1 either modifies the set of advertisement content or selects the set of advertisement content (Step S5). For example, regarding the landing page corresponding to such a set of advertisement content whose advertising effectiveness determined at Step S4 does not satisfy a predetermined condition, the information processing device 1 generates a new set of advertisement content and thus modifies the set of advertisement content of that landing page.

The predetermined condition indicates, for example, that the CTR is equal to or greater than a threshold value or that the CVR is equal to or greater than a threshold value. Alternatively, the predetermined condition can indicate that the impression rate of the landing page is equal to or greater than a threshold value. Meanwhile, the method for generating a new set of advertisement content is same as the advertisement content generation method implemented at Step S2.

Meanwhile, when a plurality of sets of advertisement content is generated at Step S2, based on the advertising effectiveness of each of a plurality of sets of advertisement content, the information processing device 1 selects the sets of advertisement content that, from among the plurality of sets of advertisement content generated at Step S2, are to be provided in future.

For example, from among the plurality of sets of advertisement content generated at Step S2, the information processing device 1 selects the sets of advertisement content having the CTR to be equal to or greater than a threshold value or having the CVR to be equal to or greater than a threshold value as the sets of advertisement content to be provided in future. Alternatively, from among the plurality of sets of advertisement content generated at Step S2, the information processing device 1 can select the sets of advertisement content having the top m number of CTRs or having the top m number of CVRs (where m is a natural number equal to or greater than “1”) as the sets of advertisement content to be provided in future.

Still alternatively, from among the plurality of sets of advertisement content generated at Step S2, the information processing device 1 either can select the sets of advertisement content having the impression rate to be equal to or greater than a threshold value or can select the sets of advertisement content having the top m number of impression rates as the sets of advertisement content to be provided in future.

Meanwhile, at Step S2, when a set of advertisement content is generated for each attribute of the user U, based on the attributes of the user U to whom the set of advertisement content is to be provided and based on the determination result obtained at Step S4, the information processing device 1 can select the sets of advertisement content to be provided in future. In that case, for example, based on the determination result obtained at Step S4 regarding each attribute of the user U to whom a set of advertisement content is to be provided; the information processing device 1 selects, for each attribute of the user U, a set of advertisement content to be provided in future.

Meanwhile, for example, from among a plurality of sets of advertisement content generated at Step S2, when no set of advertisement content has the CTR to be equal to greater than the threshold value or the CVR to be equal to or greater than the threshold value, the information processing device 1 performs an identical operation to the operation performed at Step S2 and generates a plurality of new sets of advertisement content.

At Step S5, when there is either modification or selection of a set of advertisement content, the information processing device 1 provides the modified a set of advertisement content or the selected set of advertisement content. In that case, the method for providing the set of advertisement content is same as the set of advertisement content provision method implemented at Step S3.

In the example explained above, before an advertisement delivery request is received, the information processing device 1 generates the set of advertisement content corresponding to the landing page. However, that is not the only possible example. Alternatively, the set of advertisement content corresponding to the landing page can be generated when an advertisement delivery request is received.

For example, when an advertisement delivery request sent from the terminal device 2 is received, the information processing device 1 inputs, as the input information to the generative AI, information containing the information about the landing page; and causes the generative AI to generate a set of advertisement content. Herein, the method for generating a set of advertisement content is same as the advertisement content generation method implemented at Step S2.

In the information included in the input information, the information about the media plane in which the sets of advertisement content are to be posted can also be included. For example, the information about the media plane in which the sets of advertisement content are to be posted is included in an advertisement delivery request. The information about the media plane contains at least either the text information or the image information of the media plane. The text information of the media plane represents the information about the character strings included in the media plane, and the image information of the media plane represents the information indicating the images included in the media plane.

In that case, for example, the information processing device 1 treats, as the input information, information containing instruction information, which further contains information about a character string “The information about the media plane in which the sets of advertisement content are to be posted is as follows.”, and containing information about the media plane in which the sets of advertisement content are to be posted; and causes the generative AI to generate a set of advertisement content.

In this way, the information processing device 1 receives the specification of the landing page of a set of advertisement content; inputs information containing the information about the landing page as the input information to a generative AI; and causes the generative AI to generate a set of advertisement content. Then, the information processing device 1 provides the generated set of advertisement content. As a result, the information processing device 1 becomes able to deliver a more appropriate set of advertisement content to the user U.

Given below is the detailed explanation about a configuration of an information processing system that includes the information processing device 1, the terminal devices 2, and the terminal device 3 that perform the operations as explained above.

### 2. Configuration of Information Processing System

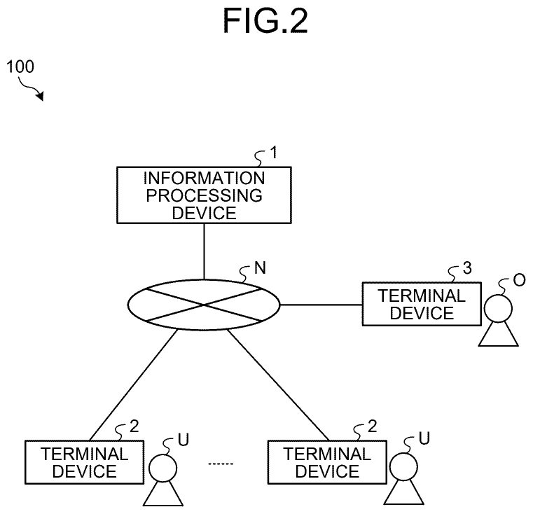

FIG. 2 is a diagram illustrating an exemplary configuration of the information processing system according to the embodiment. As illustrated in FIG. 2, an information processing system 100 according to the embodiment includes the information processing device 1, a plurality of terminal devices 2, and the terminal device 3.

The terminal devices 2 are used by mutually different users U. The terminal device 3 is, for example, the terminal device of the business operator O. Examples of the terminal devices 2 and the terminal device 3 include a notebook PC (Personal Computer), a desktop PC, a smartphone, a tablet PC, and a wearable device. Examples of a wearable device include, but are not limited to, a smart glass and a smart watch.

Each of the information processing device 1, the terminal devices 2, and the terminal device 3 is communicably connected to each other via a network N in a wired manner or a wireless manner. Meanwhile, in the information processing system 100 illustrated in FIG. 2, a plurality of information processing devices 1 can also be included.

Examples of the network N include, but are not limited to, a wide area network (WAN), such as the Internet; and a mobile communication network, such as LTE (Long Term Evolution), 4G (4th Generation), or 5G (5th Generation: the fifth generation mobile communication system).

Each of the terminal devices 2 and the terminal device 3 establishes connection with the network N via Near Field Communication such as a mobile communication network, Bluetooth (registered trademark), or a wireless LAN (Local Area Network); and becomes able to communicate with the information processing device 1.

### 3. Configuration of Information Processing Device 1

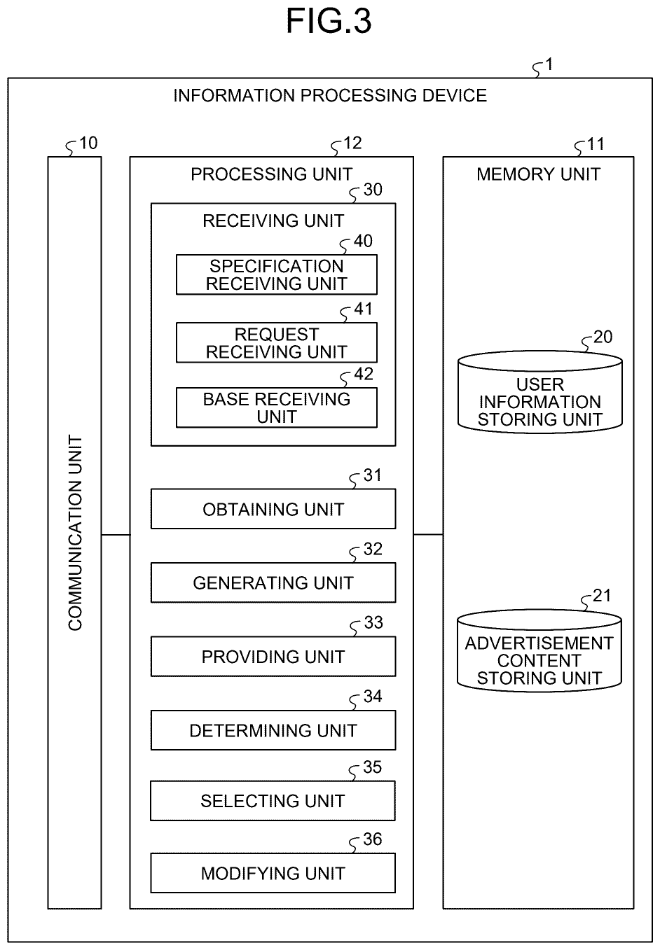

FIG. 3 is a diagram illustrating an exemplary configuration of the information processing device 1 according to the embodiment. As illustrated in FIG. 3, the information processing device 1 includes a communication unit 10, a memory unit 11, and a processing unit 12.

### 3.1. Communication Unit 10

The communication unit 10 is implemented using, for example, a communication module or a network interface card (NIC). The communication unit 10 is connected to the network N in a wired manner or a wireless manner, and communicates information with various other devices. For example, the communication unit 10 communicates information with the terminal devices 2 and the terminal device 3 via the network N.

### 3.2. Memory Unit 11

The memory unit 11 is implemented, for example, using a semiconductor memory device such as a random access memory (RAM) or a flash memory; or using a storage device such as a hard disk or an optical disc. The memory unit 11 includes a user information storing unit 20 and an advertisement content storing unit 21.

### 3.2.1. User Information Storing Unit 20

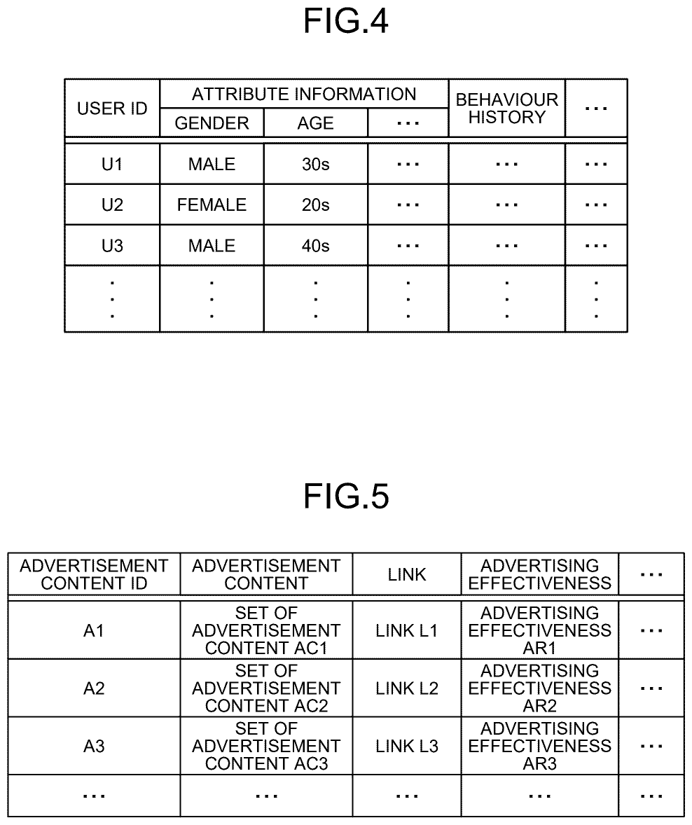

The user information storing unit 20 is used to store user information containing information related to the users U. FIG. 4 is a diagram illustrating an example of a user information table that is stored in the user information storing unit 20 of the information processing device 1 according to the embodiment. As illustrated in FIG. 4, the user information table stored in the user information storing unit 20 includes items “user ID”, “attribute information”, and “behavior history”.

The item “user ID” represents identification information enabling identification of the users U. The item “attribute information” represents the attribute information of the users U identified in the item “user ID”. For example, the item “attribute information” includes information about the psychographic attributes and information about the demographic attributes. Examples of the demographic attributes include gender, age, place of residence, and profession. Examples of the psychographic attributes include interests and concerns, lifestyle, and ideology or ideological inclination; such as travel, clothing, car, and religion.

The item “behavior history” represents the behavior history of the users U identified in the item “user ID”. For example, the behavior history of each user U includes the identification information of the sets of advertisement content provided to that user U by the processing unit 12 of the information processing device 1; the information indicating the presence or the absence of the past selection (click operations or tap operations) made by the user U regarding the sets of advertisement content provided to the user U; and the information indicating the presence or absence of browsing of each landing page.

### 3.2.2. Advertisement Content Storing Unit 21

The advertisement content storing unit 21 is used to store a variety of information related to the sets of advertisement content. FIG. 5 is a diagram illustrating an example of an advertisement content table that is stored in the advertisement content storing unit 21 of the information processing device 1 according to the embodiment.

In the example illustrated in FIG. 5, the advertisement content table stored in the advertisement content storing unit 21 includes items “advertisement content ID”, “advertisement content”, “link”, and “advertising effectiveness”. The item “advertisement content ID” represents identification information enabling identification of the sets of advertisement content, and thus represents information attached to each set of advertisement content.

The item “advertisement content” represents the sets of advertisement content identified in the item “advertisement content ID”. Examples of a set of advertisement content include, but are not limited to, a display advertisement, a listing advertisement, and a video advertisement. Examples of a display advertisement include, but are not limited to, a banner advertisement, an SNS advertisement, and a native advertisement.

The item “link” represents the link information of the landing pages of the sets of advertisement content identified in the item “advertisement content ID”, and indicates the information about URLs, for example. The item “advertising effectiveness” represents the information indicating the advertising effectiveness of the sets of advertisement content identified in the item “advertisement content ID”.

Meanwhile, in the advertisement content table stored in the advertisement content storing unit 21, for example, instead of including the link information of the landing pages, the information about the actual landing pages of the sets of advertisement content identified in the item “advertisement content ID” can be included, and some other information can also be included.

### 3.3. Processing Unit 12

The processing unit 12 is a controller and, for example, is implemented when a processor such as a central processing unit (CPU) or a micro processing unit (MPU) executes various computer programs (equivalent to an example of an information processing program), which are stored in the internal storage device of the information processing device 1, while using the RAM as the work area.

Alternatively, the processing unit 12 can be a controller and, for example, can be implemented, partially or entirely, using an integrated circuit such as an application specific integrated circuit (ASIC), a field programmable gate array (FPGA), or a general purpose graphic processing unit (GPGPU).

As illustrated in FIG. 3, the processing unit 12 includes a receiving unit 30, an obtaining unit 31, a generating unit 32, a providing unit 33, a determining unit 34, a selecting unit 35, and a modifying unit 36; and implements or executes the functions and the actions of information processing as explained below. However, the internal configuration of the processing unit 12 is not limited to the configuration illustrated in FIG. 3. Thus, as long as the information processing explained below can be performed, the processing unit 12 can have any other configuration.

### 3.3.1. Receiving Unit 30

The receiving unit 30 receives a variety of information and requests. For example, the receiving unit 30 receives a variety of information and requests sent from the terminal devices 2 of the users U, and receives a variety of information and requests sent from the terminal device 3 of the business operator O. For example, the receiving unit 30 includes a specification receiving unit 40, a request receiving unit 41, and a base receiving unit 42.

### 3.3.1.1. Specification Receiving Unit 40

The specification receiving unit 40 receives the specification of the landing page of a set of advertisement content. For example, in an advertisement generation request, either the URL of the landing page specified by the business operator O is included or the information indicating the actual landing page is included. When an advertisement generation request sent from the terminal device 3 is received, the specification receiving unit 40 receives the specification of the landing page of a set of advertisement content.

Moreover, in an advertisement generation request, the base advertisement content can also be included. The base advertisement content represents the set of advertisement content that serves as the basis of the set of advertisement content generated by the generating unit 32. In that case, when an advertisement generation request is received in which either the base advertisement content is included or the link information of the base advertisement content is included, the specification receiving unit 40 receives the base advertisement content included in the advertisement generation request.

### 3.3.1.2. Request Receiving Unit 41

The request receiving unit 41 receives an advertisement delivery request. For example, the request receiving unit 41 receives an advertisement delivery request, which is sent from the terminal device 2 or an external information processing device (for example, an advertising server), via the network N and the communication unit 10.

In an advertisement delivery request, the following information is included, for example: the information indicating the address of the terminal device 2 or the external information processing device; the information indicating the attributes of the user U of the concerned terminal device 2; and the information about the media plane in which the sets of advertisement content are to be posted. However, the information included in an advertisement delivery request is not limited to that example.

### 3.3.1.3. Base Receiving Unit 42

The base receiving unit 42 receives the base advertisement content representing the set of advertisement content that serves as the basis. For example, in an advertisement generation request, either the link information of the base advertisement content as specified by the business operator O is included or the actual base advertisement content is included. Thus, when an advertisement generation request sent from the terminal device 3 is received, the specification receiving unit 40 receives the base advertisement content.

### 3.3.2. Obtaining Unit 31

The obtaining unit 31 obtains a variety of information from an external information processing device or the memory unit 11. For example, the obtaining unit 31 receives a variety of content or the information about the users U from an external information processing device via the network N and the communication unit 10.

Moreover, the obtaining unit 31 obtains the information about the users U from the user information storing unit 20 of the memory unit 11. For example, when an advertisement delivery request is received by the request receiving unit 41, based on the identification information (for example, the user ID) included in the advertisement delivery request, the obtaining unit 31 obtains the attribute information and the behavior information of the user U as sent from an external information processing device.

Furthermore, the obtaining unit 31 obtains various sets of advertisement content from the advertisement content storing unit 21 of the memory unit 11. For example, when an advertisement delivery request is received by the request receiving unit 41, the obtaining unit 31 obtains the sets of advertisement content from the advertisement content storing unit 21 of the memory unit 11.

### 3.3.3. Generating Unit 32

The generating unit 32 generates a variety of information. For example, the generating unit 32 inputs, as the input information to a generative AI, information containing the information about the landing page received as the specification by the specification receiving unit 40; and causes the generative AI to generate a set of advertisement content.

The generative AI is, for example, a text generative AI, an image generative AI, or a multimodal generative AI. For example, a text generative AI represents a large-scale language model that is trained to estimate the next token from a token array and to output the estimated token. For example, a text generative AI is a transformer-based model or an RNN-based model, or can also be a mixed model of such models. Alternatively, a text generative AI can be a complex system used in combination with a discrimination machine meant for preventing unauthorized use.

Examples of a transformer-based model include, but are not limited to, GPT or BARD. Examples of an RNN-based model include, but are not limited to, RWKV.

An image generative AI represents an AI for generating images from texts; and examples thereof include, but are not limited to, StackGAN, AttnGAN, T2I with Transformers, and Diffusion model. Moreover, for example, a Diffusion model can be DALL-E or Stable-Diffusion.

A multimodal generative AI is a generative AI meant for generating at least either a text, or an image, or an audio from at least either a text, an image, or an audio. Examples of a multimodal generative AI include, but are not limited to, GPT-4V and CM3Leon.

Meanwhile, a generative AI is desirably trained in such a way that individual information is not included in the generation result thereof. Moreover, a generative AI can be a language model trained (for example, fine-tuned) for the dedicated purpose of generating sets of advertisement content. A generative AI is disposed in an external information processing device, and the generating unit 32 uses the generative AI via an API provided by the external information processing device. Alternatively, the generative AI can be disposed in the information processing device 1.

In the generating unit 32, the information included in the input information as the information about a landing page represents, for example, the text information included in the landing page, or the image information indicating the landing page, or the text information and the image information included in the landing page. The text information represents information indicating the character strings included in the landing page. The image information represents information indicating the images included in the landing page.

For example, the generating unit 32 inputs, as the input information to a generative AI, information containing instruction information, which represents information for instructing generation of a set of advertisement content, and containing the information about the landing page; and causes the generative AI to generate a set of advertisement content.

The instruction information included in the input information contains, for example, information about a character string “You are an advertisement creator. Based on the input information about a landing page, please generate a set of advertisement content predicted to have high advertising effectiveness for that landing page.”. Examples of the advertising effectiveness include, but are not limited to, the selectivity of the concerned set of advertisement content (for example, the click-through rate or the tap rate) and the browsing rate of the landing page.

Meanwhile, in addition to having the instruction information and the information about the landing page, the information included in the input information can further contain target information representing the information that indicates the target for the concerned set of advertisement content. For example, the target information represents information indicating the users U who are targeted in a set of advertisement content.

The attributes of each user U include, for example, the demographic attributes or the psychographic attributes of the user U. Examples of the demographic attributes of the user U include, but are not limited to, the gender, the age, the profession, the place of residence, the annual income, and the family of the user U. Examples of the psychographic attributes of the user U include, but are not limited to, the interests and concerns, the lifestyle, and the set of values of the user U.

For example, the generating unit 32 inputs, as the input information to a generative AI, information that further contains the information indicating the attributes of the user U to whom the sets of advertisement content is to be provided; and causes the generative AI to generate sets of advertisement content according to the attributes.

In that case, when the target information represents the information indicating the user U who is the target for the sets of advertisement content; the instruction information, which is included in the input information that is input to the generative AI, further contains the information about a character string “The attributes of the user targeted in the set of advertisement content are as follows.”.

Meanwhile, the generative AI used in the generating unit 32 can be a generative AI that is fine-tuned while treating, as the information for learning, the information about the landing pages of the sets of advertisement content having high advertising effectiveness and the information containing a plurality of combinations of such sets of advertisement content.

In that case, the generating unit 32 inputs, to the generative AI, the input information containing the information about a landing page, and causes the generative AI to generate a set of advertisement content; or inputs, to the generative AI, the input information further containing the target information, and causes the generative AI to generate a set of advertisement content.

In this way, the generating unit 32 can input, to a generative AI, the input information that not only contains the information about the landing page but also contains either one or both of the instruction information and the target information; and can cause the generative AI to generate a set of advertisement content.

Meanwhile, the generating unit 32 can cause the generative AI to generate a plurality of sets of advertisement content. For example, the generating unit 32 inputs, to the generative AI, the input information containing information about a character string “Generate 10 sets of advertisement content for the . . . landing page.”, and causes the generative AI to generate 10 sets of advertisement content.

Furthermore, for example, the information processing device 1 can input, to the generative AI, the input information containing the information about a landing page, and can cause the generative AI to output the information meant for collecting information related to the material to be included in the set of advertisement content.

For example, in the case of using the API provided by OpenAI, the information processing device 1 implements the function-calling function and causes the generative AI to output the information meant for collecting the information related to the material to be included in the set of advertisement content. The input information that is input to the generative AI has the following information included therein, for example: information containing function definition information, which is meant for defining the function name and the arguments of that function, and information about the landing page. Meanwhile, instead of including the function definition information, information indicating the name of the material can also be included in the input information.

For example, based on the information output from the generative AI, the generating unit 32 collects the information related to the material to be included in the set of advertisement content; inputs, to the generative AI, the information related to the material to be included in the set of advertisement content; and causes the generative AI to generate a set of advertisement content.

Moreover, the generating unit 32 can input, to the generative AI, the input information containing the information about the landing page and can cause the generative AI to generate the information meant for generating a set of advertisement content; and then can input the generated information to the generative AI and cause the generative AI to generate a set of advertisement content.

Meanwhile, when the base advertisement content is received by the base receiving unit 42, the generating unit 32 inputs, as the input information to the generative AI, information containing the information about the landing page and containing the base advertisement content; and causes the generative AI to generate a set of advertisement content that is similar to the base advertisement content. The base advertisement content represents the set of advertisement content that serves as the basis of the set of advertisement content generated by the generating unit 32.

For example, the generating unit 32 inputs, to the generative AI, the input information that contains the instruction information meant for causing the generative AI to generate a set of advertisement content similar to the base advertisement content, that contains the information about the landing page, and that contains the base advertisement content; and causes the generative AI to generate a set of advertisement content that is similar to the base advertisement content.

In that case, the instruction information contains, for example, the information of a character string “You are an excellent advertisement creator. Based on the input information about a landing page, please generate a set of advertisement content for that landing page. Please make the set of advertisement content, which is to be generated, similar to the input set of advertisement content serving as the basis.”. However, that is not the only possible example.

Moreover, using the generative AI, the generating unit 32 generates a new set of advertisement content of the landing page corresponding to the advertisement content identified by the modifying unit 36, and updates the set of advertisement content of that landing page. The method for generating a new set of advertisement content is same as the advertisement content generation method explained earlier.

When the generating unit 32 generates a single set of advertisement content in response to an advertisement generation request, the set of advertisement content identified by the modifying unit 36 is a set of advertisement content whose advertising effectiveness determined by the determining unit 34 does not satisfy a predetermined condition.

Moreover, the sets of advertisement content identified by the modifying unit 36 represent a plurality of sets of advertisement content which is generated by the generating unit 32 in response to an advertisement generation request and for which the determining unit 34 has determined that the advertising effectiveness does not satisfy a predetermined condition. In that case, the generating unit 32 generates a plurality of new sets of advertisement content using the generative AI.

Meanwhile, when the API provided by OpenAI is used, the instruction information represents the information included in a system message indicating that “role” represents a message of the generative AI. Alternatively, the instruction information can represent the information included in a user message indicating that “role” represents a message from the user. Moreover, the information about the landing page, the target information, and the base advertisement content represent the information included in a user message. Alternatively, such information can represent the information included in a system message.

Meanwhile, when an advertisement delivery request is received by the request receiving unit 41, the generating unit 32 can also generate a set of advertisement content corresponding to the landing page for which the specification is received by the specification receiving unit 40.

For example, when an advertisement delivery request is received by the request receiving unit 41, the generating unit 32 inputs, as the input information to the generative AI, information containing the information about the landing page for which the specification is received by the specification receiving unit 40; and causes the generative AI to generate a set of advertisement content. The method for generating a set of advertisement content is same as the advertisement content generation method explained earlier.

In the information included in the input information, the information about the media plane in which the sets of advertisement content are to be posted can also be included. For example, the information about the media plane in which the sets of advertisement content are to be posted is included in an advertisement delivery request. The information about the media plane contains at least either the text information or the image information of the media plane. The text information of the media plane represents the information about the character strings included in the media plane, and the image information of the media plane represents the information indicating the images included in the media plane.

In that case, the generating unit 32 inputs, as the input information to the generative AI, information about the media plane in which the sets of advertisement content are to be posted; and causes the generative AI to generate a set of advertisement content according to the media plane.

For example, the generating unit 32 treats, as the input information, information containing instruction information, which further contains information about a character string “The information about the media plane in which the sets of advertisement content are to be posted is as follows.”, and containing information about the media plane in which the sets of advertisement content are to be posted; and causes the generative AI to generate a set of advertisement content.

### 3.3.4. Providing Unit 33

The providing unit 33 provides a variety of information via the communication unit 10 and the network N. For example, the providing unit 33 provides the sets of advertisement content, which are generated by the generating unit 32, to the users U and the business operator O.

For example, when an advertisement delivery request sent from the terminal device 2 of the user U is received, the providing unit 33 sends, to the terminal device 2, the set of advertisement content generated by the generating unit 32. With that, the user U is provided with the set of advertisement content generated by the generating unit 32.

For example, when a plurality of sets of advertisement content corresponding to a single landing page is generated by the generating unit 32, the providing unit 33 provides the sets of advertisement content to the user U. For example, from among a plurality of sets of advertisement content generated by the generating unit 32, the providing unit 33 selects, either randomly or according to a predetermined rule, a single set of advertisement content and provides the selected set of advertisement content to the user U.

After providing the user U with the sets of advertisement content that are generated by the generating unit 32, the providing unit 33 provides the user U with the set of advertisement content that is selected for future provision by the selecting unit 35 from among a plurality of sets of advertisement content. Thus, from among a plurality of sets of advertisement content, the providing unit 33 excludes the sets of advertisement content that are not selected by the selecting unit 35 for provision to the user U. As a result, the information processing device 1 becomes able to stop the provision of the sets of advertisement content having low advertising effectiveness from among a plurality of sets of advertisement content generated using the generative AI.

When a set of advertisement content corresponding to each attribute of the user U is generated by the generating unit 32, the providing unit 33 sends, to the terminal device 2, the sets of advertisement content that corresponds to the attributes identified in the information included in the advertisement delivery request, and provides the user U with the sets of advertisement content generated by the generating unit 32.

### 3.3.5. Determining Unit 34

Based on the behavior history of the user U as obtained by the obtaining unit 31, the determining unit 34 determines the advertising effectiveness of each set of advertisement content provided by the providing unit 33.

For example, when a plurality of sets of advertisement content is generated by the generating unit 32 in response to a single advertisement generation request, the determining unit 34 determines the advertising effectiveness of each of the plurality of sets of advertisement content provided by the providing unit 33.

Examples of the advertising effectiveness determined by the determining unit 34 include, but are not limited to, the CTR and the CVR. Alternatively, for example, after the concerned set of advertisement content has been delivered to the user U, the impression rate of the landing page due to the user U can be treated as the advertising effectiveness.

The determining unit 34 can determine the advertising effectiveness of the set of advertisement content corresponding to each attribute of the user U to whom the sets of advertisement content are to be provided. For example, corresponding to each combination of the gender, the age, and the place of residence of the user U to whom the sets of advertisement content are to be provided (for example, a man in his twenties and living in Tokyo or a woman in her thirties and living in Osaka), the determining unit 34 determines the advertising effectiveness of the set of advertisement content.

### 3.3.6. Selecting Unit 35

Based on the determination result obtained by the determining unit 34, the selecting unit 35 selects the set of advertisement content to be provided from among a plurality of sets of advertisement content generated by the generating unit 32.

For example, when a plurality of sets of advertisement content is generated by the generating unit 32, based on the advertising effectiveness of each of the plurality of sets of advertisement content, the selecting unit 35 selects the set of advertisement content to be provided in future from among the plurality of sets of advertisement content generated by the generating unit 32. As a result, for example, from among the plurality of sets of advertisement content generated by the generating unit 32, except for one or more sets of advertisement content having high advertising effectiveness, the selecting unit 35 can exclude the other sets of advertisement content from being considered for future provision.

For example, from among a plurality of sets of advertisement content generated by the generating unit 32, the selecting unit 35 selects the sets of advertisement content having the CTR to be equal to or greater than a threshold value or having the CVR to be equal to or greater than a threshold value as the sets of advertisement content to be provided in future. Alternatively, from among the plurality of sets of advertisement content generated by the generating unit 32, the selecting unit 35 can select the sets of advertisement content having the top m number of CTRs or having the top m number of CVRs (where m is a natural number equal to or greater than “1”) as the sets of advertisement content to be provided in future.

Still alternatively, from among the plurality of sets of advertisement content generated by the generating unit 32, the selecting unit 35 either can select the sets of advertisement content having the impression rate to be equal to or greater than a threshold value or can select the sets of advertisement content having the top m number of impression rates as the sets of advertisement content to be provided in future.

Meanwhile, when the generating unit 32 generates a set of advertisement content for each attribute of the user U, based on the attributes of the user U to whom the sets of advertisement content are to be provided and based on the determination result obtained by the determining unit 34; the selecting unit 35 can select, for each attribute of the user U, a set of advertisement content to be provided in future. In that case, for example, based on the determination result obtained by the determining unit 34 regarding each attribute of the user U to whom the sets of advertisement content are to provided, the selecting unit 35 can select, for each attribute of the user U, a set of advertisement content to be provided in future.

### 3.3.7. Modifying Unit 36

Based on the determination result obtained by the determining unit 34, in place of the set of advertisement content generated by the generating unit 32, the modifying unit 36 modifies the set of advertisement content to be provided in future.

For example, the selecting unit 36 identifies a set of advertisement content whose advertising effectiveness determined by the determining unit 34 does not satisfy a predetermined condition. Then, the selecting unit 36 causes the generating unit 32 to use the generative AI and generate a new set of advertisement content of the landing page corresponding to the identified set of advertisement content, and thus modifies the set of advertisement content of the landing page.

The predetermined condition indicates, for example, that the CTR is equal to or greater than a threshold value or that the CVR is equal to or greater than a threshold value. Alternatively, the predetermined condition can indicate that the impression rate of the landing page is equal to or greater than a threshold value.

Moreover, the modifying unit 36 identifies a plurality of sets of advertisement content which is generated by the generating unit 32 in response to an advertisement generation request and whose advertising effectiveness does not satisfy a predetermined condition. Then, the modifying unit 36 causes the generating unit 32 to generate a plurality of new sets of advertisement content of the landing pages corresponding to the identified sets of advertisement content, and thus modifies the sets of advertisement content of the landing pages.

Meanwhile, the selecting unit 36 can use a generative AI for generating a new set of advertisement content of the landing page that corresponds to the set of advertisement content whose advertising effectiveness determined by the determining unit 34 does not satisfy a predetermined condition. In that case, the method implemented by the selecting unit 36 for generating a new set of advertisement content is same as the advertisement content generation method implemented by the generating unit 32.

### 4. Sequence of Operations

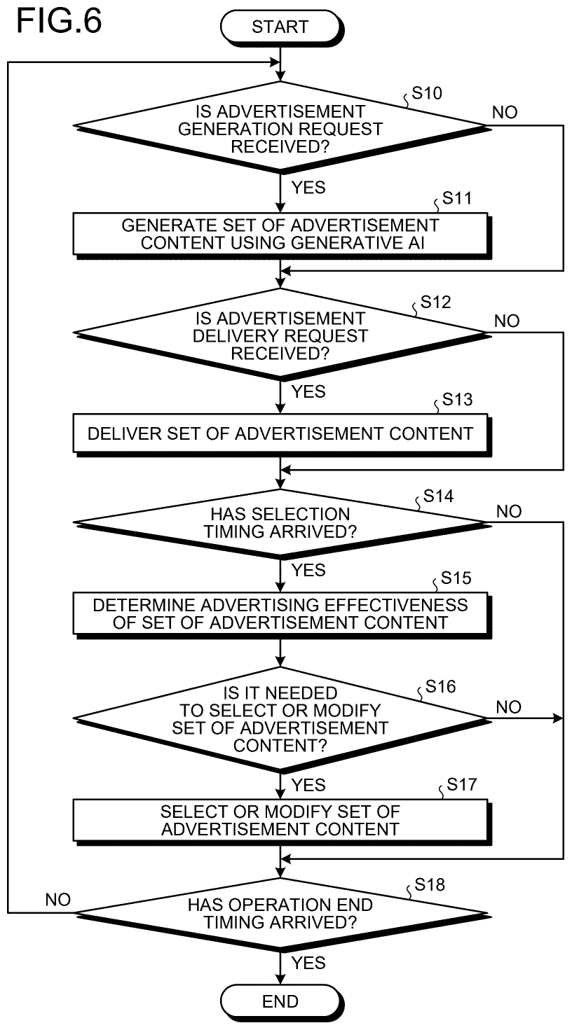

Given below is the explanation of a sequence of the information processing performed by the processing unit 12 of the information processing device 1 according to the embodiment. FIG. 6 is a flowchart for explaining an example of the information processing performed by the processing unit 12 of the information processing device 1 according to the embodiment.

As illustrated in FIG. 6, the processing unit 12 of the information processing device 1 determines whether or not an advertisement generation request is received (Step S10). If it is determined that an advertisement generation request is received (Yes at Step S10), the processing unit 12 generates a set of advertisement content using a generative AI (Step S11).

When the operation at Step S11 ends or if it is determined that an advertisement generation request is not received (No at Step S10), the processing unit 12 determines whether or not an advertisement delivery request is received (Step S12). If it is determined that an advertisement delivery request is received (Yes at Step S12), the processing unit 12 delivers a set of advertisement content to the terminal device 2 that issued the advertisement delivery request (Step S13).

When the operation at Step S13 ends or if it is determined that an advertisement deliver request is not received (No at Step S12), the processing unit 12 determines whether or not the selection timing has arrived (Step S14). For example, the selection timing represents the timing arriving after the elapse of a predetermined period of time since the generation of a set of advertisement content, or represents the timing specified by the business operator O, or represents the timing that arrives when the number of delivered sets of advertisement content reaches a predetermined number.

If it is determined that the selection timing has arrived (Yes at Step S14), the processing unit 12 determines the advertising effectiveness of the set of advertisement content (Step S15) and, based on that determination result, determines whether or not the concerned set of advertisement content needs to be selected or modified (Step S16). If it is determined that the set of advertisement content needs to be selected or modified (Yes at Step S16), the processing unit 12 either selects or modifies the set of advertisement content (Step S17).

When the operation at Step S17 ends, or if it is determined that the selection timing has not arrived (No at Step S14), or it is determined that the concerned set of advertisement content need not be selected or updated (No at Step S16); the processing unit 12 determines whether or not the operation end timing has arrived (Step S18). For example, when the power supply to the information processing device 1 is switched off, the processing unit 12 determines that the operation end timing has arrived.

If it is determined that the operation end timing has not arrived (No at Step S18), the system control returns to Step S10. When it is determined that the operation end timing has arrived (Yes at Step S18), the processing unit 12 ends the operations illustrated in FIG. 6.

### 5. Modification Example

In the example explained above, when the base advertisement content is received by the base receiving unit 42, the generating unit 32 causes a generative AI to generate a set of advertisement content that is similar to the base advertisement content. However, that is not the only possible example.

For example, the generating unit 32 can identify a plurality of other landing pages that is similar to the landing page received as the specification by the specification receiving unit 40 and, from among the sets of advertisement content corresponding to the identified other landing pages, can decide that the set of advertisement content having the highest advertising effectiveness represents the base advertisement content.

For example, the generating unit 32 vectorizes the landing page that is received as the specification by the specification receiving unit 40, and decides that the set of advertisement content corresponding to the other landing page having the highest degree of vector similarity represents the base advertisement content.

For example, the vectorization is performed according to the embedding based on a sentence embedding model (for example, a transformer-based model). The vector information of a landing page is expressed using, for example, vectors having a few hundred dimensions. However, that is not only possible example.

Meanwhile, in the case of generating a single set of advertisement content for a plurality of landing pages, the generating unit 32 can input, to the generative AI, the information containing the information about the plurality of landing pages; and can cause the generative AI to generate a set of advertisement content.

Moreover, the generating unit 32 can input, as the input information to a multimodal generative AI, information containing image information and containing instruction information that is used to instruct the output of an explanatory text about the types of the images specified in the image information; and can obtain, from the generative AI, the information about the explanatory text indicating the types of the images specified in the image information. The image information can represent either the image information indicating the landing page, or the image information about the media plane, or the image information about the base advertisement content.

In that case, instead of inputting the image information indicating the landing page, or the image information about the media plane, or the image information about the base advertisement content, the generating unit 32 can input, as the input information to a generative AI, information containing the information about the explanatory text about the types of the images specified in the image information; and can cause the generative AI to generate a set of advertisement content.

Meanwhile, the processing unit 12 of the information processing device 1 can include a learning unit that fine-tunes the generative AI using the information for learning which contains the sets of advertisement content generated by the generating unit 32 and contains the advertising effectiveness determined by the determining unit 34 regarding each set of advertisement content.

### 6. Hardware Configuration

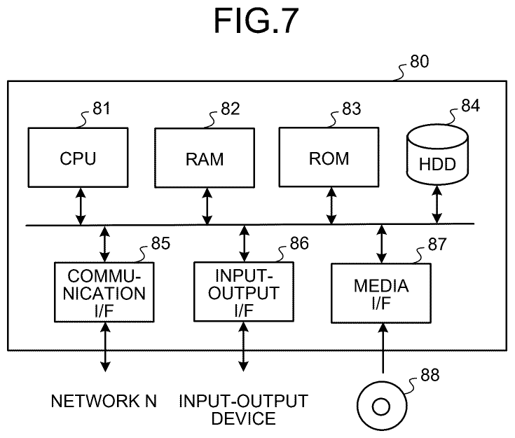

The information processing device 1 according to the embodiment described above is implemented, for example, using a computer 80 having a configuration as illustrated in FIG. 7. FIG. 7 is a hardware configuration diagram illustrating an example of the computer 80 that implements the functions of the information processing device 1 according to the embodiment. The computer 80 includes a CPU 81, a RAM 82, a read only memory (ROM) 83, a hard disk drive (HDD) 84, a communication interface (I/F) 85, an input-output interface (I/F) 86, and a media interface (I/F) 87.

The CPU 81 performs operations based on computer programs stored in the ROM 83 or the HDD 84, and controls the other constituent elements. The ROM 83 is used to store a boot program that is executed by the CPU 81 at the time of booting the computer 80, and to store computer programs that are dependent on the hardware of the computer 80.

The HDD 84 is used to store computer programs to be executed by the CPU 81, and to store the data used by the computer programs. The communication interface 85 receives data from other devices via the network N (see FIG. 2) and sends the data to the CPU 81; and sends the data generated by the CPU 81 to other devices via the network N.

The CPU 81 controls output devices, such as a display and a printer, and input devices, such as a keyboard or a mouse, via the input-output interface 86. The CPU 81 obtains data from an input device via the input-output interface 86. Moreover, the CPU 81 outputs the generated data to an output device via the input-output interface 86.

The media interface 87 reads computer programs or data stored in a recording medium 88, and provides the CPU 81 with the read data via the RAM 82. The CPU 81 loads such computer programs from the recording medium 88 into the RAM 82 via the media interface 87, and executes the loaded computer programs. Examples of the recording medium 88 include an optical recording medium such as a digital versatile disc (DVD) or a phase change rewritable disk (PD); a magneto-optical recording medium such as a magneto-optical (MO) disk; a tape medium; a magnetic recording medium; or a semiconductor memory.

For example, when the computer 80 functions as the information processing device 1 according to the embodiment, the CPU 81 of the computer 80 executes the computer programs loaded in the RAM 82 and implements the functions of the processing unit 12. Moreover, the data in the memory unit 11 is stored in the HDD 84. Herein, the CPU 81 of the computer 80 reads the computer programs from the recording medium 88 and executes them. However, as another example, the CPU 81 can obtain the computer programs from another device via the network N.

### 8. Miscellaneous

Of the processes described above in the embodiment, all or part of the processes explained as being performed automatically can be performed manually. Similarly, all or part of the processes explained as being performed manually can be performed automatically by a known method. The processing procedures, the control procedures, specific names, various data, and information including parameters described in the embodiment or illustrated in the drawings can be changed as required unless otherwise specified. For example, a variety of information illustrated in the drawings is not limited to the illustrated information.

The constituent elements of the device illustrated in the drawings are merely conceptual, and need not be physically configured as illustrated. The constituent elements, as a whole or in part, can be separated or integrated either functionally or physically based on various types of loads or use conditions.

For example, the information processing device 1 can be implemented using a terminal device and a server computer, or can be implemented using a plurality of server computers. Alternatively, depending on the functions, the information processing device 1 can be implemented by calling an external platform using an API or network computing. Thus, the configuration of the information processing device 1 can be varied with flexibility.

Meanwhile, the embodiment and the modification example described above can be appropriately combined without causing any contradiction in the processing details.

### 9. Effects

As explained above, the information processing device 1 according to the embodiment includes the specification receiving unit 40, the generating unit 32, and the providing unit 33. The specification receiving unit 40 receives the specification of the landing page of a set of advertisement content. The generating unit 32 inputs, as the input information to a generative AI, information containing the information about the landing page received as the specification by the specification receiving unit 40; and causes the generative AI to generate a set of advertisement content. The providing unit 33 provides the set of advertisement content generated by the generating unit 32. As a result, the information processing device 1 becomes able to deliver a more appropriate set of advertisement content to the user U.

The generating unit 32 inputs, as the input information to the generative AI, information further containing the information indicating the attributes of each user U to whom the sets of advertisement content are to be provided; and causes the generative AI to generate sets of advertisement content corresponding to the attributes. As a result, the information processing device 1 becomes able to deliver more appropriate sets of advertisement content to the user U.

Moreover, the generating unit 32 inputs, as the input information to the generative AI, information further containing the information about the media plane in which the sets of advertisement content are to be posted; and causes the generative AI to generate a set of advertisement content according to the media plane. As a result, the information processing device 1 becomes able to deliver a more appropriate set of advertisement content to the user U.

Furthermore, the generating unit 32 causes the generative AI to generate a plurality of sets of advertisement content, and the providing unit 33 provides the sets of advertisement content generated by the generating unit 32. As a result, the information processing device 1 becomes able to deliver more appropriate sets of advertisement content to the user U.

The information processing device 1 further includes the determining unit 34 that determines the advertising effectiveness of a plurality of sets of advertisement content provided by the providing unit 33; and includes the selecting unit 35 that, based on the determination result obtained by the determining unit 34, selects the set of advertisement content to be provided from among the sets of advertisement content generated by the generating unit 32. The providing unit 33 provides the set of advertisement content selected by the selecting unit 35. As a result, the information processing device 1 becomes able to deliver a more appropriate set of advertisement content to the user U.

Moreover, the determining unit 34 determines the advertising effectiveness of the set of advertisement content for each attribute of the user U to whom the sets of advertisement content are to be provided. Based on the attributes of the user U to whom the sets of advertisement content are to be provided and based on the determination result obtained by the determining unit 34, the selecting unit 35 selects the sets of advertisement content to be provided. As a result, the information processing device 1 becomes able to deliver more appropriate sets of advertisement content to the user U.

The information processing device 1 further includes the base receiving unit 42 that receives the base advertisement content representing the set of advertisement content that serves as the basis. The generating unit 32 inputs, as the input information to the generative AI, information containing the information about the landing page and containing the base advertisement content received by the base receiving unit 42; and causes the generative AI to generate a set of advertisement content that is similar to the base advertisement content. As a result, the information processing device 1 becomes able to deliver a more appropriate set of advertisement content to the user U.

The information processing device 1 further includes the request receiving unit 41 that receives an advertisement delivery request. When an advertisement delivery request is received by the request receiving unit 41, the generating unit 32 inputs, as the input information to the generative AI, information containing the information about the landing page received as the specification by the specification receiving unit 40; and causes the generative AI to generate a set of advertisement content. As a result, the information processing device 1 becomes able to generate, in real time, a more appropriate set of advertisement content and deliver it to the user U.

Herein, although the description is given about the embodiment of the application concerned, the technical scope of the present invention is not limited to the embodiment described above, and can be construed as embodying various deletions, alternative constructions, and modifications that may occur to one skilled in the art that fairly fall within the basic teaching herein set forth.

Moreover, the terms “section”, “module”, and “unit” mentioned above can be read as “device” or “circuit”. For example, an obtaining unit can be read as an obtaining device or an obtaining circuit.

According to an aspect of the embodiment, it becomes possible to deliver more appropriate sets of advertisement content to the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a specification receiving unit that receives specification of a landing page of a set of advertisement content;
a generating unit that inputs, as input information to a generative AI, information containing information about the landing page which is received as specification by the specification receiving unit, and causes the generative AI to generate a set of advertisement content; and
a providing unit that provides the set of advertisement content generated by the generating unit.

2. The information processing device according to claim 1, wherein the generating unit inputs, as input information to the generative AI, information further containing information that indicates an attribute of user to whom the set of advertisement content is to be provided, and causes the generative AI to generate a set of advertisement content corresponding to the attribute.

3. The information processing device according to claim 1, wherein the generating unit inputs, as input information to the generative AI, information further containing information about a media plane in which the set of advertisement content is to be posted, and causes the generative AI to generate a set of advertisement content according to the media plane.

4. The information processing device according to claim 1, wherein
the generating unit causes the generative AI to generate a plurality of sets of advertisement content, and
the providing unit provides the plurality of sets of advertisement content generated by the generating unit.

5. The information processing device according to claim 4, further comprising:
a determining unit that determines advertising effectiveness of the plurality of sets of advertisement content provided by the providing unit; and
a selecting unit that, based on determination result obtained by the determining unit, selects a set of advertisement content to be provided from among the plurality of sets of advertisement content generated by the generating unit, wherein
the providing unit provides the set of advertisement content selected by the selecting unit.

6. The information processing device according to claim 5, wherein
the determining unit determines advertising effectiveness of the set of advertisement content corresponding to each attribute of user to whom the set of advertisement content is to be provided, and
based on attribute of user to whom the set of advertisement content is to be provided and based on determination result obtained by the determining unit, the selecting unit selects the set of advertisement content to be provided.

7. The information processing device according to claim 4, further comprising a base receiving unit that receives base advertisement content representing a set of advertisement content which serves as basis, wherein
the generating unit inputs, as the input information to the generative AI, information containing information about the landing page and containing the base advertisement content, and causes the generative AI to generate a set of advertisement content which is similar to the base advertisement content.

8. The information processing device according to claim 1, further comprising a request receiving unit that receives an advertisement delivery request, wherein
when the advertisement delivery request is received by the request receiving unit, the generating unit inputs, as input information to a generative AI, information containing information about the landing page received as specification by the specification receiving unit, and causes the generative AI to generate a set of advertisement content.

9. An information processing method implemented in a computer, comprising:
specification-receiving that includes receiving specification of a landing page of a set of advertisement content;
generating that includes inputting, as input information to a generative AI, information containing information about the landing page which is received as specification by the specification receiving unit, and causing the generative AI to generate a set of advertisement content; and
providing the set of advertisement content generated at the generating.

10. A non-transitory computer readable storage medium having stored an information processing program that causes a computer to execute:
specification-receiving that includes receiving specification of a landing page of a set of advertisement content;
generating that includes inputting, as input information to a generative AI, information containing information about the landing page which is received as specification by the specification receiving unit, and causing the generative AI to generate a set of advertisement content; and
providing the set of advertisement content generated at the generating.
